(19) United States
(12) Patent Application Publication
(10) Pub. No.: US 2005/0083323 A1
(43) Pub. Date: Apr. 21, 2005

(54) Light emitting display device

(75) Inventors: Gen Suzuki, Yonezawa-shi (JP); Naoki Yazawa, Yonezawa-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: TOHOKU PIONEER CORPORATION, Tendo-shi (JP)

(21) Appl. No.: 10/967,271

(22) Filed: Oct. 19, 2004

(30) Foreign Application Priority Data
Oct. 21, 2003 (JP) 2003-360806

(51) Int. Cl. G09G 5/00

(52) U.S. Cl. 345/207

(57) ABSTRACT

A light emitting display device 1 characterized by forming one display screen by combining a plurality of light emitting display units comprising intensity control means for measuring a light emission intensity by a light emitting element (organic EL element 20) which is formed above/on a transparent substrate 11 and which includes an anode electrode 12, a cathode electrode 16, at least one organic light emission functional layer (13,14,15) between the electrodes to control the light emission intensity of the light emitting element above/on the substrate 11 within a predetermined range and deterioration state reporting means for detecting a deterioration state of the light emitting element above/on the substrate 11 to report the state.

### BACKGROUND OF THE INVENTION

1. Field of the Invention

The present invention relates to a light emitting display device in which a light emitting display panel provided with an intensity control function that can set the light emission intensities of light emitting elements to a predetermined value respectively and individually and a deterioration state reporting function that can detect and report a deterioration state of a light emitting element is employed and which forms a large size display screen by arranging a large number of these light emitting display panels.

2. Description of the Related Art

For example in an event place or hall, a theater, a sports ground, or the like, in order to provide video information for a large number of audiences/spectators, a display device equipped with a large area display screen is installed. In recent years, also in monitoring operation circumstances of various plants and the like, monitoring traffic information, or the like, arrangements have been made in which monitoring is performed according to job positions by a large number of surveillance persons, utilizing a large size screen. Further, a display device by such a large size screen has played an active part in the field of advertisement and has been utilized in advertisement mediums for projecting a promotion video, a preview of a movie, a commercial message of a new product, or the like by installing this large size screen on a wall surface or the like of a building in a busy place such as a downtown area and the like.

Many of display devices by a conventional large size screen as described above employ for example light emitting diodes (LEDs) as respective pixels. That is, respective LEDs are arranged in a matrix pattern in vertical and horizontal directions, and by selectively illuminating these LEDs, an image is displayed. (For example, refer to Japanese Patent Application Laid-Open No. 5-88629.)

The light emission intensity of this LED is relatively high, and the LED has a property of a long lifetime. However, since each LED forms one dot (pixel) of an image, there is a physical limit in increasing its density, and there is a blemish in its resolution. Thus, for example in a case where characters are displayed, visual recognizability is considerably deteriorated. When full color display is to be performed, it is necessary to mount LEDs by which R (red), G (green), B (blue) are illuminated, respectively, in one pixel, and thus LEDs whose number is three times are needed. Thus, a result that the weight of an entire display device is increased is incurred.

Meanwhile, recently, an organic electroluminescent (EL) display device having properties of high efficiency, thin shape, light weight, high resolution, wide angle of field, and the like has attracted attention. This is because of backgrounds one of which is that by employing, in the light emitting layer of an EL element employed in an EL display device, an organic compound which enables an excellent light emission characteristic to be expected, a high efficiency and a long life which make an EL element satisfactorily practicable have been advanced. This organic EL display device has been adopted in a display such as of a part of portable equipment, vehicle equipment, or the like, utilizing the above-mentioned properties.

Thus, it is expected that the above-mentioned properties of the organic EL display device can be enjoyed as they are, when the organic EL display device is utilized instead of a conventional LEDs which form light emitting pixels, in the above-mentioned large area display screen. However, respective light emitting pixels in an EL display device are formed by forming films of organic EL layers at intersecting positions between data electrode lines and scan electrode lines as is well-known. Therefore, it is difficult to arrange continuing data electrode lines and scan electrode lines, covering the entire surface of a large display screen. Even if this can be realized, in a case where utilizing ITO specifically as anode side data electrode lines is considered, the electrical resistance of the electrode lines becomes large, causing a difficulty in putting them to practical use, and further it becomes difficult to repair a defective part generated in a part of the screen.

Then, it may be considered that by dividing an EL display device, for example, into rectangular small screens to form light emitting display units each of which can divide and display an image by itself, and by arranging a large number of these light emitting display units in vertical and horizontal directions, a large display screen is formed. Constructing a display device in such a way that the EL display device is made into small screen light emitting display units as described above so that an image can be divided and displayed may be considered to be an extension of an organic EL display device which is made to fit for practical use in the existing circumstances, and it is expected that realization thereof is not particularly accompanied by great difficulty.

However, in the case where respective light emitting display units by an EL display device are gathered to form a large area display screen as described above, technical problems to be solved as described below are supposed. Such problems are problems of changes with time and temperature dependency of the intensity of an EL display element as described later and are problems of the practical lifetime of an EL display element, accompanied by changes with time of the intensity. Problems of changes with time and temperature dependency of the intensity of an EL display element and of the practical lifetime will be described below.

An organic EL element can be electrically shown by an equivalent circuit as shown in FIG. 1, and can be replaced by a structure composed of a diode element E constituting a light emitting element and a parasitic capacitance element C which is connected in parallel to this diode element. Therefore, the organic EL element has been considered as a capacitive light emitting element. When a light emission drive voltage is applied to this organic EL element, at first, electrical charges corresponding to the electric capacity of this element flow into the electrode as a displacement current and are accumulated. It can be considered that when the drive voltage then exceeds a determined voltage (light emission threshold voltage=Vth) peculiar to this element, current begins to flow from the electrode (anode side of the diode element E) to an organic layer constituting the light emitting layer so that the element emits light at an intensity proportional to this current.

FIG. 2 shows light emission characteristics of such an organic EL element. According to these, the organic EL element emits light at an intensity L approximately proportional to drive current I as shown in FIG. 2A and emits light while current I flows drastically when the drive voltage V is the light emission threshold voltage Vth or higher as shown by the solid line in FIG. 2B. In other words, when the drive voltage is the light emission threshold voltage Vth or lower, current rarely flows in the EL element, and the EL element does not emit light. Therefore, the EL element has an intensity characteristic that in a light emittable region in which the drive voltage is higher than the threshold voltage Vth, the greater the value of the voltage V applied to the EL element, the higher the light emission intensity L thereof as shown by the solid line in FIG. 2C.

Meanwhile, the organic EL element has a characteristic that physical properties of the element change due to passage of light emission drive time so that the resistance value of the element itself becomes greater. Thus, as shown in FIG. 2B, the V-I characteristic of the organic EL element changes in a direction shown by the arrow (characteristic shown by the broken line) due to actual use time, and therefore the intensity characteristic is also deteriorated. The organic EL element has a problem that variations in the initial intensity occur also due to for example variations in deposition at the time of film formation of this element, and thus it becomes difficult to express intensity gradation faithful to an input video signal.

For example, as one means for realizing a full color display image by the organic EL elements, a parallel type RGB method in which films of organic materials which enable light emission of red (R), green (G), and blue (B) are respectively formed and are arranged has been proposed. A full color display device utilizing such a RGB method has a problem that color balance (white balance) drifts accompanied by passage of use time after all since cumulative light emission times of respective R, G and B elements differ and since respective speeds of the intensity decline differ due to light emission materials of respective organic EL elements constituting respective light emitting pixels of R, G and B.

Further, it has been known that the intensity property of an organic EL elements changes due to changes in the temperature roughly as shown by broken lines in FIG. 2C. That is, while the EL element has the characteristic that the greater the value of the voltage V applied thereto, the higher the light emission intensity L thereof in the light emittable region in which the drive voltage is higher than the light emission threshold voltage, the EL element also has a characteristic that the higher the temperature becomes, the lower the light emission threshold voltage becomes. Accordingly, the intensity of the EL element has a temperature dependency that the higher the temperature becomes, the lower the applied voltage by which light emission becomes possible and that the EL element is brighter at high temperature time and is darker at lower temperature time though the same light emittable voltage is applied.

Therefore, in a case where a full color display image by the parallel type RGB method is realized, there is a problem that color balance by respective R, G and B drifts similarly also by changes of the environmental temperature.

In the case where respective light emission display units by the EL display device are gathered to form a large area display screen as described above, following problems are expected to occur, being influenced by changes with time of intensities of EL display elements. That is, for example in a case where some of light emitting display units are replaced in order to repair defective parts, an unnatural display condition in which only replaced parts are seen very brightly compared to other parts or the like is expected.

An organic EL element has a temperature dependency in the intensity thereof as described above although such a problem cannot necessarily be said to be a problem peculiar to the case where the light emitting display units are gathered. Thus, the gathered units structure also has a technical problem that for example color balance drifts, being influenced by the environmental temperature.

Further, in the case where this type of display device in which respective light emitting display units are gathered to form a large area display screen is considered, it is necessary to contemplate the practical lifetime based on changes with time of the intensity of the EL display element from the viewpoint of special characteristics of the use thereof. With respect to the lifetime, it is expected that variations occur considerably in respective display units. Accordingly, in the case where a display device by this large size screen is employed, for example in an event place or the like, necessity of adopting operational preparedness in which a display unit expected to reach the light emission lifetime thereof during the event period is replaced in advance occurs.

### SUMMARY OF THE INVENTION

The present invention relates to a display device in which a large number of above-described light emitting units are arranged in vertical and horizontal directions as described above to form a large display screen, and particularly, it is an object of the present invention to provide a display device which can be put into practical use by effectively restraining changes of the intensity characteristics which are due to the above-mentioned changes with time or changes in the light emission intensity accompanied by fluctuation of the environmental temperature and by being provided with a function by which the deterioration state of the display unit can be grasped.

A light emitting display device according to the present invention which has been developed in order to solve the object is characterized by forming one display screen by combining a plurality of light emitting display units comprising intensity control means for measuring a light emission intensity by a light emitting element which is formed above/on a transparent substrate and which includes an anode electrode, a cathode electrode, at least one organic light emission functional layer between the electrodes to control the light emission intensity of the light emitting element above/on the substrate within a predetermined range and deterioration state reporting means for detecting a deterioration state of the light emitting element above/on the substrate to report the state.

### BRIEF DESCRIPTION OF THE DRAWINGS

FIG. 1 is an electrical circuit diagram equivalently showing an organic EL element;

FIG. 2 is characteristic views showing characteristics of an organic EL element;

FIG. 3 is a front view showing a state in which light emitting display units are gathered to form a display device by a large size screen;

FIG. 4 is a side view showing a state in which the display device shown in FIG. 3 is mounted;

FIG. 5 is a cross-sectional view showing one example of a display panel which constitutes the light emitting display unit;

FIG. 6 is a cross-sectional view showing an example for detecting the amount of light reflected within the substrate of the light emitting display unit;

FIG. 7 is cross-sectional views showing other examples for detecting the amount of light reflected within the substrate;

FIG. 8 is a connection diagram showing one example in which the present invention is applied to an active drive type display panel;

FIG. 9 is a connection diagram showing a specific example of intensity control employed in the structure shown in FIG. 8;

FIG. 10 is a flowchart for explaining a routine for setting the driving power and deterioration of state of EL elements adopted in the structure shown in FIGS. 8 and 9;

FIG. 11 is a connection diagram showing one example in which the present invention is applied to a passive drive type display panel;

FIG. 12 is a connection diagram showing a specific example of intensity control employed in the structure shown in FIG. 11;

FIG. 13 is a flow chart for explaining a routine for setting the driving power and deterioration of state of EL elements adopted in the structure shown in FIGS. 11 and 12;

FIG. 14 is a cross-sectional view showing another structure for detecting the amount of light reflected within a substrate of a light emitting display unit;

FIG. 15 is a connection diagram showing a photoelectric transfer circuit suitably employed in the structure shown in FIG. 14; and

FIG. 16 is a cross-sectional view showing further another structure for detecting the amount of light reflected within a substrate of a light emitting display unit.

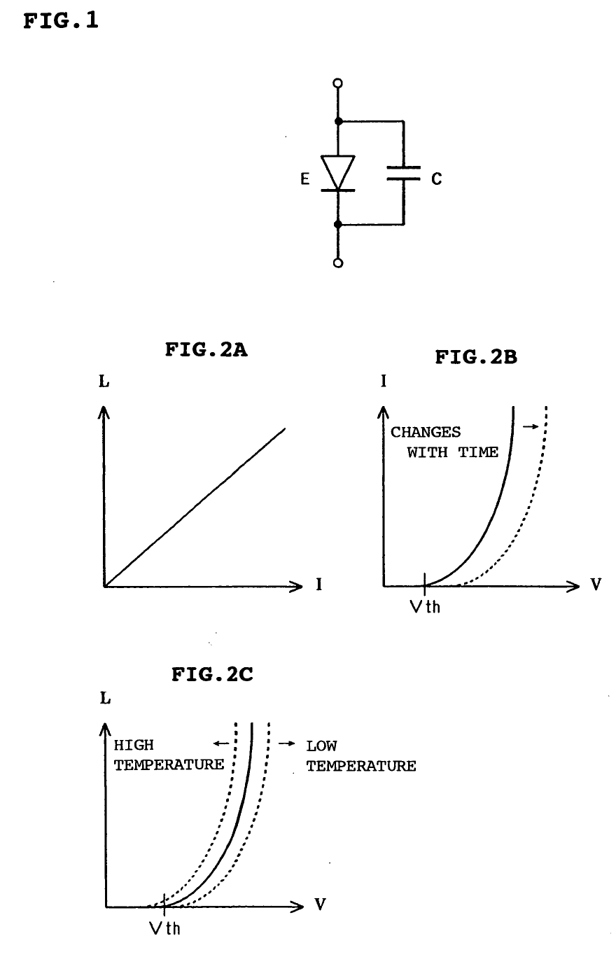

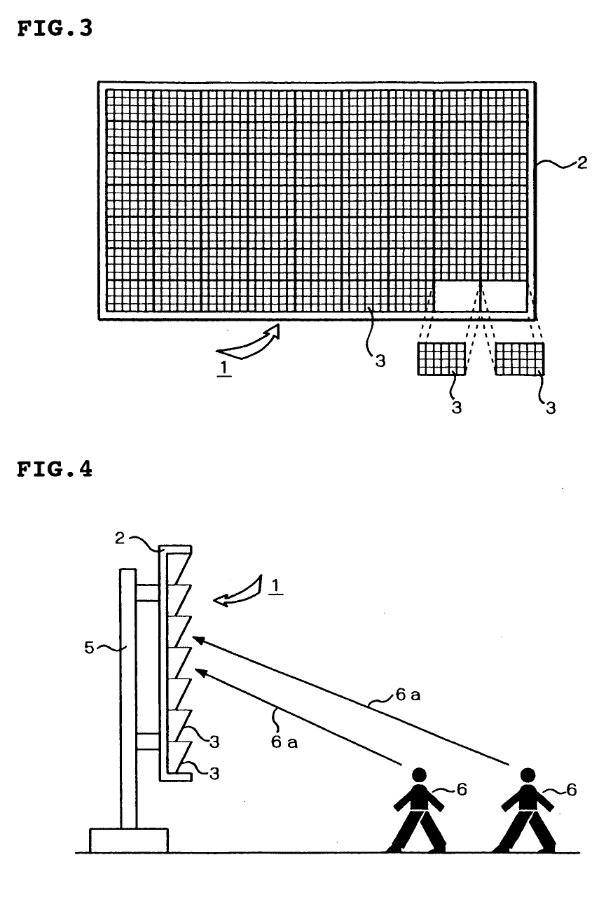

### DESCRIPTION OF THE PREFERRED EMBODIMENTS

A light emitting display device according to the present invention will be described below with reference to the drawings. First, FIG. 3 schematically shows a state in which a display device according to the present invention is seen from the front thereof. As shown in FIG. 3, rectangular light emitting display units 3 in which organic EL elements are light emitting pixels are arranged in vertical and horizontal directions with respect to a rectangular frame body 2 constituting an outline of a light emitting display device 1 to form a light emitting display device by a large size screen. The respective light emitting display units 3, as depicted in a lower right part of FIG. 3, are detachably constructed with respect to the rectangular frame body 2, and with this structure, maintenance work such as replacement for the light emitting display unit 3 or the like can be implemented as the need arises.

The respective light emitting display units 3 hold drive ICs or the like so that an image can be divided and displayed in each of them as described later, and are constructed so as to receive the driving power via power supply line extending along, for example, the rear surface of the frame body 2 and to respectively receive an image signal for dividing and displaying an image via a bus line though such a structure is not shown in FIG. 3.

In the form shown in FIG. 3, although all of the light emitting display units 3 have a rectangular shape in which the sizes of the outward forms thereof are the same, with respect to this size of the outward form, mutually different appropriate shapes may be adopted. In the form shown in FIG. 3, although the respective display units 3 are regularly arranged so as to fill up the entire area within the rectangular frame body 2 by the display units 3 to form a long sideways screen, the screen shape is not limited to this, and for example, an area to a part of which the light emitting display units 3 are not attached may be formed.

FIG. 4 shows a state in which a state in which the light emitting display device 1 shown in FIG. 3 is mounted is seen from its side surface side, wherein the back surface of the frame body 2 is attached to a structure 5, and the respective light emitting display units 3 are attached to the front surface of this frame body 2 to form the display device 1 as described above. As schematically shown in FIG. 4, in a case where a display surface (screen) of the display device 1 is positioned above the eye positions of surveillance persons 6, it is desired that the respective display units 3 are arranged so that the respective display surfaces thereof are tilted downwardly some amount, so that the display surfaces are perpendicular to the lines of sight or gaze lines 6a of the surveillance persons 6.

By constructing the display device in the above manner, even when this type of display device is utilized, for example in the outdoors, the visual recognizability of an image can be fully ensured. This can be said to be a special effect which can be achieved by this embodiment in which a screen is formed by gathering the respective light emitting display units 3 as described above. Further, a structure that both left and right end sides of a screen are curved toward the surveillance person side can be obtained easily by positively utilizing the above-described structure. Moreover, it is possible to form a cylindrical screen as if the screen surrounded the entire circumference of a thick pillar.

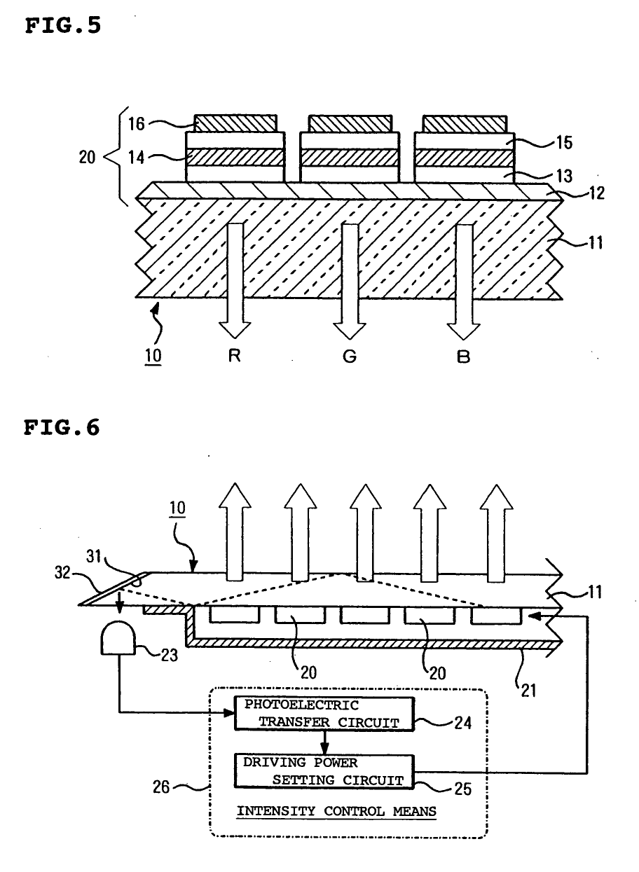

FIG. 5 explains the structure of a single unit of the light emitting display unit 3 and particularly shows one example of the structure of organic EL elements by a cross-sectional view. In this example, shown is a full color display panel by a parallel type RGB method in which films of organic EL light emitting layers which emit respective R (red), G(green), and B(blue) colors are individually formed and arranged. In a light emitting display panel 10, as shown in FIG. 5, stacked are anode electrodes 12 by ITO or the like, positive hole transport layers 13 as a light emission functional layer, light emitting layers 14, electron transport layers 15, and cathode electrodes 16 in this order for example above/on a transparent glass substrate 11, and an organic EL element 20 is formed by these.

Organic compounds by which respective R (red), G(green), and B(blue) colors can be emitted are employed in the light emitting layers 14. In this manner, by employing respective R, G and B colors as subpixels and by allowing the respective R, G and B color lights to be emitted in a direction perpendicular to the substrate surface via the substrate 11, a full color display image can be obtained. The display device according to the present invention is not to utilize only a full color display panel as described above but also can be applied to a monochrome light emitting display panel in which an organic material for the same light emitting color is employed in the light emitting layer 14.

Meanwhile, in the light emitting display panel 10 of the above-described structure, the light from the light emitting layer 14 is not emitted only in the direction perpendicular to the substrate surface of the glass substrate 11 but is also emitted in all directions. Therefore, a part of the light emitted from the light emitting layer 14 is incident onto the substrate 11 at a predetermined angle, and a phenomenon occurs in which such a light is totally reflected within the substrate 11, treating the substrate surfaces as boundary surfaces. The inventors of the present application and the like have known that by measuring the amount of light which is totally reflected as described above, adopting several means as described alter, the momentary intensity of an EL element in the light emitting display panel can be grasped, and have verified that with respect to the measurement results, relatively high accuracy can be obtained.

FIG. 6 shows, by a schematic view, the structure of intensity control means by which the amount of light totally reflected within the substrate is detected, treating the substrate surfaces of the substrate 11 as boundary surfaces, and by which light emission driving power supplied to the EL elements is set, based on the above-described viewpoint. That is, as shown in FIG. 6, the EL elements 20 including the light emitting layers 14 shown in FIG. 5 are formed on one surface of the transparent substrate 11 made of glass forming the light emitting display panel 10. Sealing means for sealing the EL elements 20 between the transparent substrate 11 and the sealing means, for example, a sealing member 21 made of stainless steel, is attached by a glue or the like, on one surface of the substrate 11 on which the EL elements 20 are formed.

With this structure shown in this FIG. 6, a part of light which is emitted from the EL elements 20 and which is incident on the place surface of the substrate 11 at a predetermined angle or lower is totally reflected within the substrate 11, treating the substrate surfaces as boundary surfaces as shown by the broken line. In the embodiment shown in FIG. 6, a reflective surface 31 is formed on an end portion of the transparent substrate 11 at a predetermined angle with respect to the substrate surface of the transparent substrate, and the light which is totally reflected treating the substrate surfaces as boundary surfaces and which is shown by the broken line is projected on the rear surface side of the substrate 11 by this reflective surface 31.

For example a pin diode 23 as a photodetector constituting photoelectric transfer means is disposed in the rear surface side of the transparent substrate 11 constituting the display panel 10 so that the amount of light reflected by the reflective surface 31 can be detected. In this case, it may be also considered that a reflective material 32 is imparted to the reflective surface 31 as the need arises.

With this structure, the momentary intensity emitted from the EL elements 20 is converted into an electrical signal by the pin diode 23. The voltage of the electrical signal obtained by the pin diode 23 is amplified in a photoelectric transfer circuit 24, and the electrical signal is supplied to a driving power setting circuit 25. This driving power setting circuit 25 controls so that the light emission driving power supplied to the EL elements 20 formed in the display panel 10 is set to an appropriate value as described later. Thus, the light emission intensity of the EL elements 20 formed in the display panel 10 is regulated so as to be within a predetermined range all the time. In this embodiment, intensity control means 26 is composed of the photoelectric transfer circuit 24 and the driving power setting circuit 25.

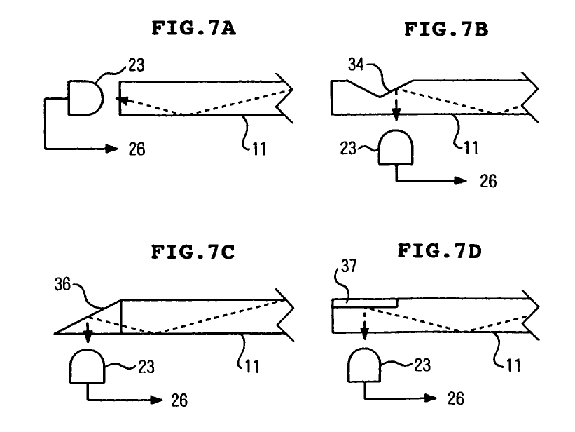

FIG. 7 explains another means for detecting the amount of light reflected within the transparent substrate 11 constituting the display panel 10. This FIG. 7 shows the structures in the vicinity of one end portion of the substrate 11 and positional relationships between the end portion of the substrate 11 and the pin diode 23. In FIG. 7A, the pin diode 23 is arranged over one end surface of the transparent substrate 11. In this structure, in a case where the light totally reflected within the substrate 11 reaches the end surface of the transparent substrate 11, since the incident angle of said end surface becomes a predetermined angle or greater in this end surface, the light passes through the end surface of the substrate 11. Accordingly, by the pin diode 23 disposed over the end surface of the transparent substrate 11, the light emission intensity of the EL elements 20 can be detected.

In the form shown in FIG. 7B, a groove portion 34 constructed in such a manner that the cross-sectional shape of the end portion of the transparent substrate 11 is a V-like shape is imparted along a portion in the vicinity of the end portion of the transparent substrate 11. One surface of the groove portion is utilized as a reflective surface (reference numeral therefor is designated by 34 which is the same as that for the groove portion). In this structure also, similarly to the example shown in FIG. 6, for example the pin diode 23 as photoelectric transfer means is disposed in the rear surface side of the transparent substrate 11 constituting the display panel 10 so that the amount of light reflected by the reflective surface 34 can be detected.

In the form shown in FIG. 7C, a prism member 36 is disposed on the end surface of the transparent substrate 11, and the light which is reflected within the transparent substrate 11 via this prism member 36 and which is shown by the broken line is outputted to the rear surface side of the substrate 11. In this structure also, for example the pin diode 23 is arranged in the rear surface side of the transparent substrate 11 so that the amount of light reflected by the prism member 36 can be detected.

In the structure shown in FIG. 7C, even when a light diffusion member formed by a milky-white material into the same shape as that of the prism member 36 is arranged instead of the prism member 36, the amount of light can be detected similarly. In the case where a light diffusion member is utilized, by disposing a light diffusion member 37 formed into a flat plate shape along one surface of the transparent substrate 11 for example as shown in FIG. 7D, the amount of light reflected within the transparent substrate 11 can be detected similarly.

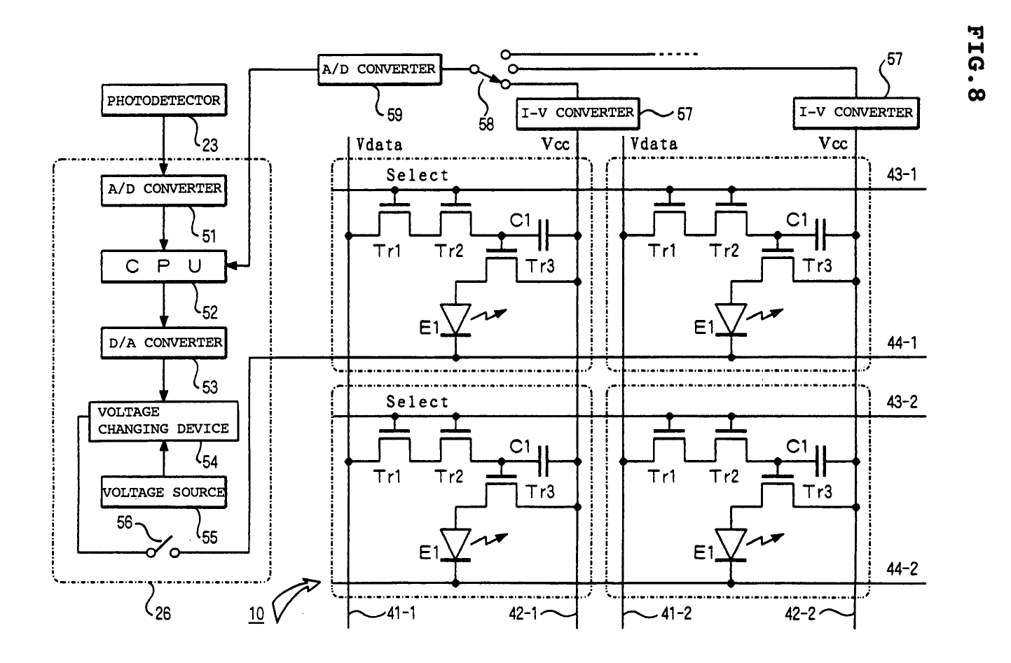

FIG. 8 shows an example of a structure employing an active drive type display panel as the light emitting display panel 10 in the structure shown in FIG. 6 so as to light emission control this active drive type display panel, utilizing the intensity control means 26. In the display panel 10 in the embodiment shown in this FIG. 8, a large number of data electrode lines 41-1, 41-2, . . . to which data signal Vdata corresponding to a video data supplied from an unillustrated data driver is respectively supplied are arranged in a column direction, and a large number of power supply lines 42-1, 42-2, . . . are arranged in parallel to the data electrode lines. Meanwhile, a large number of scan electrode lines 43-1, 43-2, . . . to which scan signal Select supplied from an unillustrated scan driver is supplied are arranged in a row direction, and a large number of power supply control lines 44-1, 44-2, . . . are arranged in parallel to the scan electrode lines.

In a circuit structure including the EL element 20 corresponding to a unit light emitting pixel, a control TFT (thin film transistor), a drive TFT, and a capacitor are provided. In FIG. 8, the EL element 20 is designated by reference character E1. In the form shown in FIG. 8, first and second transistors Tr1, Tr2 are employed as control TFTS, the scan signal Select for scanning rows is imparted sequentially to respective gates of these transistors via the scan electrode lines 43-1, 43-2, . . . .

In this embodiment, the sources and drains of the first and second control transistors Tr1, Tr2 are connected in series. The sources of the first control transistors Tr1 are connected to the data electrode lines 41-1, 41-2, . . . , and the drains of the second control transistors Tr2 are connected to the gates of drive transistors Tr3 and to one ends of capacitors C1.

The other ends of the capacitors C1 and the sources of the drive transistors Tr3 are connected to the power supply lines 42-1, 42-2, . . . , and the drains of the drive transistors Tr3 are connected to the anode terminals of the EL elements E1. The cathode terminals of the EL elements E1 are connected to the power supply control lines 44-1, 44-2, . . . In FIG. 8, although structures corresponding to four pixels are depicted for convenience of space, respective structures described above are similarly constructed corresponding to respective organic EL elements E1 arranged in the display panel 10.

In a light emission control operation for unit pixels of the display panel 10 in which a plurality of such circuits are arranged in the row and column directions, an ON voltage Select is supplied to the gates of the first and second control transistors Tr1, Tr2 during an address period. In this manner, current corresponding to the video data signal Vdata flows in the capacitors C1 via the respective sources and drains of the transistors Tr1, Tr2 connected in series, and thus the capacitors C1 are charged. This charge voltage is supplied to the gates of the drive transistors Tr3, and the transistors Tr3 allow current corresponding to the gate voltage thereof and a control voltage supplied to the power supply control lines 44-1, 44-2, . . . to flow in the organic EL elements E1, whereby the EL elements E1 emit light.

Meanwhile, when the gate voltages of the control transistors Tr1, Tr2 become an OFF voltage, the transistors Tr1, Tr2 become so-called cutoff. However, the gate voltages of the drive transistors Tr3 are maintained by electrical charges accumulated in the capacitors C1. The drive current to the organic EL elements E1 by the drive transistors Tr3 is maintained until a next scan, and thus light emission of the EL elements is also maintained.

Meanwhile, in FIG. 8, the output from the pin diode 23 as a photodetector which detects the amount of light from the EL elements E1 is supplied to the intensity control means shown by a block 26. This intensity control means 26 is composed of an A/D converter 51, a CPU 52 working as an operation control function, a D/A converter 53, a voltage changing device 54, a voltage source 55, and a switch 56.

Specific examples for respective blocks constituting the intensity control means 26 will be described later. The intensity control means 26 provided in this embodiment operates to appropriately set the voltage value in the power supply control lines 44-1, 44-2, . . . , based on a photodetection voltage generated by the pin diode 23.

In a case where the amount of light received in the pin diode 23 becomes lower than a predetermined reference value for example by changes with time, fluctuation of the environmental temperature or the like, as a result the intensity control means 26 controls the voltage value of the power supply control lines 44-1, 44-2, . . . so that the value becomes lower (or the value is drawn to a more negative voltage side), whereby this state is set. Thus, the drive current flowing in the EL elements E1 increases, and corresponding to this increment, a state in which the light emission intensity of the EL elements is increased is set. In a case where the amount of light received in the pin diode 23 becomes increased more than the predetermined reference value for example by fluctuation of the environmental temperature, or the like, an operation opposite to the above is performed, and a state in which the light emission intensity of the EL elements is decreased is set. In short, data corresponding to the amount of light received in the pin diode 23 is fed back, and thus the light emission intensities of the respective EL elements are controlled.

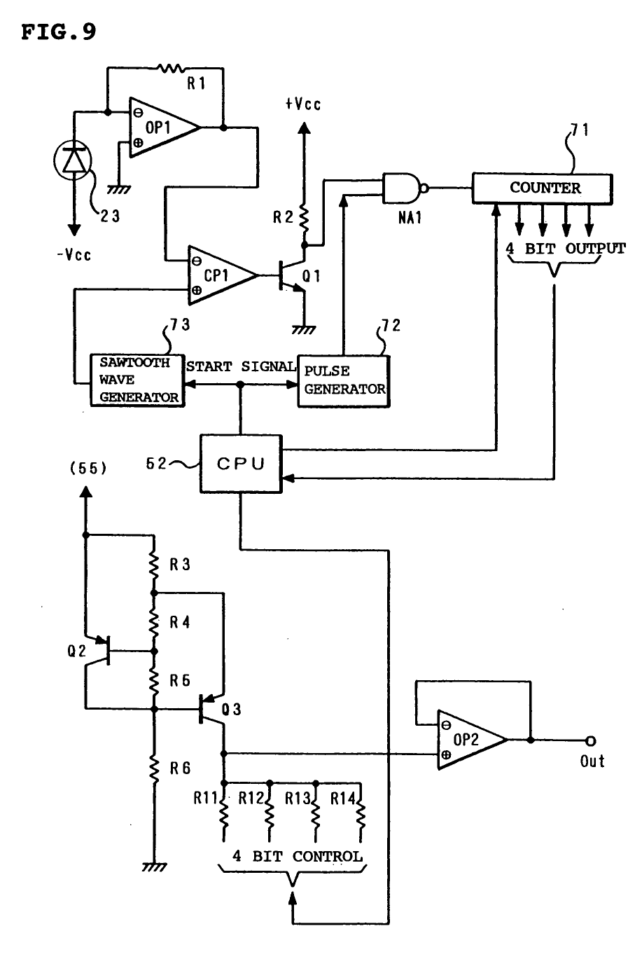

FIG. 9 shows a more specific circuit structure for controlling the light emission intensities of the respective EL elements, utilizing the output of the pin diode provided as a photodetector shown in FIG. 8. The output of the pin diode 23 is supplied to a negative feedback amplifier composed of an operational amplifier OP1 and a feedback resistor R1, and thus a voltage corresponding to the output of the pin diode is impedance converted and is outputted at the output terminal of the op amp OP1. Therefore, this op amp OP1 achieves a function equivalent to the photoelectric transfer circuit 24 shown in FIG. 6.

The output of the op amp OP1 is supplied to a comparator CP1. A switching transistor Q1 provided with a collector resistance R2, a NAND gate NA1, a counter 71, a pulse generator 72, and a sawtooth wave generator 73, as well as the comparator CP1, form the A/D converter 51 shown in FIG. 8. The CPU 52 shown in FIG. 9 corresponds to the CPU 52 shown in FIG. 8.

In FIG. 9, a start signal is supplied from the CPU 52 to the pulse generator 72 and the sawtooth wave generator 73, and in synchronization with this a counter reset signal is supplied from the CPU 52 to the counter 71. By these operations, first, the counter value in the counter 71 is reset. After this, by a pulse output from the pulse generator 72, a countup output is supplied to the counter 71 by the NAND gate NA1, and the counter 71 begins to count up.

Meanwhile, the output of the op amp OP1 is supplied to the inverting input terminal of the comparator CP1, and the sawtooth wave from the sawtooth wave generator 73 is supplied to the noninverting input terminal of the comparator CP1. The comparator CP1 allows the transistor Q1 to be switched when the analog output level from the op amp OP1 corresponds to the level of the sawtooth wave supplied from the sawtooth wave generator 73. Thus, supplying of the countup output from the NAND gate NA1 to the counter 71 is stopped.

That is, when the start signal is supplied from the CPU 52, the counter 71 begins to count and operates to supply a count value corresponding to the time until the analog output level from the op amp OP1 corresponds to the level of the above-mentioned sawtooth wave to the CPU 52 as an output of several bits (in the example shown in FIG. 9, the output of 4 bits). Thus, intensity information acquired by the pin diode 23 is fetched in the CPU 52 as digital data.

The CPU 52, when receiving the digital data, determines whether an initial intensity corresponds to a set value or not as described later, and outputs a correction value in a case where the CPU 52 determines that the initial intensity does not correspond, whereby based on this, a set operation of the driving power given to the EL elements is implemented. An example of a case where the set operation of the driving power imparted to the EL elements is performed by a calculation operation of the CPU 52 will be described in detail later.

Meanwhile, a specific combination structure of the D/A converter 53 and the voltage changing device 54 in FIG. 8 is shown in the lower half in FIG. 9. The combination of the transistors Q2, Q3 and resistors R3-R6 in this FIG. 9 corresponds to the voltage changing device 54 in FIG. 8, and a group of resistors R11-R14 connected to the collector of the transistor Q3 functions as the D/A converter 53 in FIG. 8.

The pnp transistors Q2 and Q3 in FIG. 9 constitute a constant current circuit. A constant voltage from the voltage source 55 shown in FIG. 8 is supplied to the emitter of the transistor Q2, and the base thereof is connected to the voltage source 55 via the resistors R3 to R4. The collector thereof is connected to the base thereof via the resistor R5 and to a reference potential point (ground) via the resistor R6.

The emitter of the transistor Q3 is connected to a connection point of the resistors R3 and R4, the base thereof is connected to the collector of the transistor Q2, and the collector of the transistor Q3 is connected to respective one ends of the group of resistors R11-R14 which function as a D/A converter 42. In this structure, when current flows from the voltage source 55 to the respective resistors R3 to R4, R5 and R6, an electrical potential of approximately 0.6 volts rises between the base and emitter of the transistor Q3, and the transistor Q3 is turned on. Then, current flows in the resistor R3 so that the voltage between the base and emitter of the transistor Q2 reaches about 0.6 volts, causing the transistor Q2 to be turned on so as to regulate the base current of the transistor Q3.

Thus, since both voltages between the bases and emitters of the transistors Q2, Q3 are locked to about 0.6 volts, constant current flows in the resistor R3, and this constant current flows in the group of resistors R11-R14 connected to the collector of the transistor Q3. Here, the group of resistors R11-R14 are utilized to set the driving power given to the respective EL elements based on the correction value outputted by the above-mentioned calculation operation of the CPU 52. That is, one ends of the resistors R11-R14 are connected for example to the reference potential point (ground), selectively or in a combined state, corresponding to the driving power which are set by the CPU 52 and which are given to the respective EL elements.

Therefore, in the example shown in FIG. 9, the collector potential of the transistor Q3 is regulated by control of 4 bits, and this collector potential is outputted from the output terminal Out of an op amp OP2 which functions as a buffer amplifier. The output voltage generated at the output terminal Out of the amp OP2 is supplied to the power supply control lines 44-1, 44-2, . . . via the switch 56 shown in FIG. 8 so that the cathode potentials of the respective EL elements E1 are changed, and as a result, the drive current value flowing in the respective EL elements E1 is changed so as to regulate the light emission intensities of the EL elements E1 so that the intensities become a predetermined light emission intensity.

With this intensity control function, the intensities of the EL elements can be effectively restrained from decreasing which is for example due to changes with time. Accordingly, the respective light emitting display units 3 shown in FIGS. 3 and 4 maintain the light emission intensities of the EL elements within a predetermined range and operate to restrain variations in the light emission intensity from occurring for each light emitting display unit. Therefore, in the form shown in FIGS. 3 and 4, in a case where the light emitting display unit 3 is exchanged, occurrence of variations that the exchanged light emitting display unit 3 emits light more brightly compared to other units or the like can be restrained.

Meanwhile, in the embodiment shown in FIG. 8, current-to-voltage converters 57 detecting the values of currents flowing in the power supply lines 42-1, 42-2, . . . lie on the respective power supply lines 42-1, 42-2 . . . These converters 57 are disposed in order to verify a deterioration state of the EL element by detecting terminal current flowing in the respective EL elements E1. The respective outputs of the current-to-voltage converters 57 are alternatively selected by a select switch 58 and are converted into digital data by an A/D converter 59. This digital data is supplied to the CPU 52 to be written in an unillustrated data memory (memory means) disposed in the CPU 52, so that the deterioration state of the EL element based on the terminal current flowing in the EL elements E1 is determined.

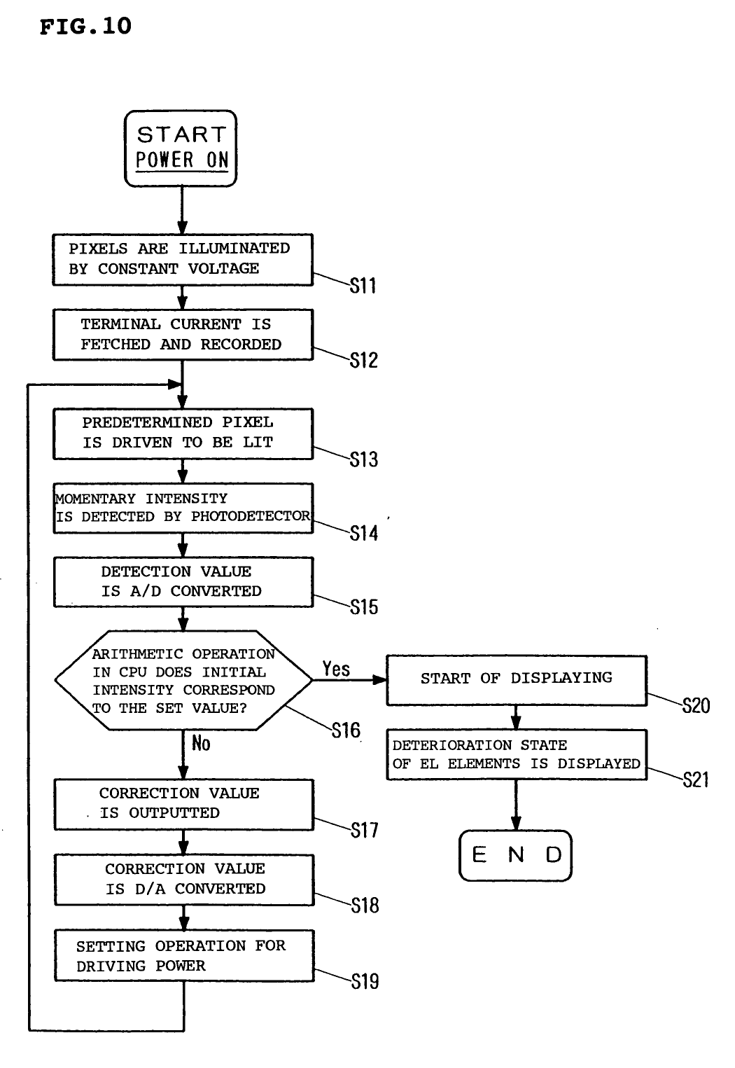

With respect to the active drive type light emitting display units 3 shown in FIGS. 8 and 9, FIG. 10 explains a control routine for setting of the driving power thereof and for reporting the deterioration state of the EL element. The routine shown in this FIG. 10 is executed respectively for each light emitting display unit 3 in a state in which the light emitting display units 3 are arranged in vertical and horizontal directions as shown in FIGS. 3 and 4 to construct a large size screen and in which an operational power supply thereof is switched on. The routine shown in this FIG. 10 can also be executed in a single unit of the light emitting display unit 3.

In FIG. 10, in step S11 after start by turning the power supply on, the respective pixels in the light emitting display units 3 are illuminated by a constant voltage. As shown in step S12, an operation in which the terminal current is fetched and is recorded is performed. This operation correspond to an operation that the current-to-voltage converters 57 shown in FIG. 8 detect current flowing in the respective power supply lines 42-1, 42-2, . . . , convert this into digital data by the A/D converter 59, and write this digital data in the illustrated data memory (memory means) arranged in the CPU 52. The data written in this data memory is utilized to report the deterioration state of the element in a later display step.

Then, in step S13, a predetermined pixel in the display panel 10 constituting the light emitting display units 3 is driven to be lit. As shown in step S14, an operation in which an momentary intensity based on lighting of the predetermined pixel is detected is implemented by a photodetector, that is, the pin diode.

An intensity detection output by the photodetector is analog to digital converted as shown in step S15, and that digital data is fetched into the CPU 52. This operation has already been described with reference to FIG. 8. Then, as shown in step S16, arithmetic processing is performed in the CPU 52, and a comparison test is performed as to whether the initial intensity corresponds to a set value or not. That is, a predetermined set value (standard intensity data) is retained in the CPU 52, and comparison with digital data based on the measured intensity fetched in to the CPU 52 is performed. In a case where the initial intensity does not correspond to the set value (No) is determined in step S16, a correction value corresponding to the comparison result is outputted as shown in step S17.

In this case, the value of digital data corresponding to the intensity fetched into the CPU 52 changes by the physical, positional, relationship between the predetermined pixel driven to be lit in the display panel 10 constituting the light emitting display units 3 and for example the pin diode 23 as a photodetector. Therefore, in the comparison test operation performed in step S16 shown in FIG. 9, it is desired that an attenuation characteristic of light based on a positional relationship between the position of the predetermined pixel driven to be lit and a photodetector is utilized as a parameter so that the correction value is outputted.

A correction value acquired in step S17 shown in FIG. 10 is digital to analog converted as shown in step S18. In this D/A conversion, the collector potential of the transistor Q3 is regulated by control of 4 bits as shown in the example already described, with reference to FIG. 9. In this manner, the electrical potential of the output terminal Out of the op amp OP2 which functions as a buffer amplifier, that is, the electrical potential supplied to the power supply control lines 44-1, 44-2, . . . shown in FIG. 8, is regulated, so that a set operation for the driving power shown in step S19 is performed.

In the control routine shown in FIG. 10, process returns from step S19 to step S13 again, and a similar set operation is repeated. In step S16, in a case where it is determined that the initial intensity corresponds to a set value (Yes), process returns to step S20, so that displaying an image, utilizing all pixels in the display panel 10, is started. In this embodiment, the deterioration state of the EL element is displayed as shown in step S21 at the same time as the beginning of displaying. In this process, digital data based on the terminal current fetched in step S12 is utilized.

In this case, digital data which becomes a reference showing the degree of deterioration of an element is stored in the CPU 52, for example by rank, and comparison with the digital data based on the terminal current fetched in step S12 is implemented. Reporting means is driven based on the difference between comparison results. For example, in a case where it is determined that the deterioration of an element has advanced considerably, means by which the entire surface of the display panel 10 constituting the light emitting display units 3 is lit red color or the like can be considered as the means for reporting this state. Means by which a light emission color is changed in accordance with its advance degree or the like can also be adopted. Further, it can also be considered that the degree of deterioration is displayed on the display unit 3 by numerical values.

In a case where a light emitting display panel is utilized which is constructed in such a manner that full color is reproduced by synthesizing light emission colors which correspond to respective R, G and B colors and which are from EL elements as described above, respective routines shown in FIG. 10 are performed corresponding to EL elements prepared for respective colors. In this case, respective standard intensity data corresponding to respective EL elements of R, G, B is retained in the CPU 52 so that the driving power is regulated respectively. Thus, disorder of white balance accompanied by changes with time or fluctuation of the environmental temperature can be corrected effectively.

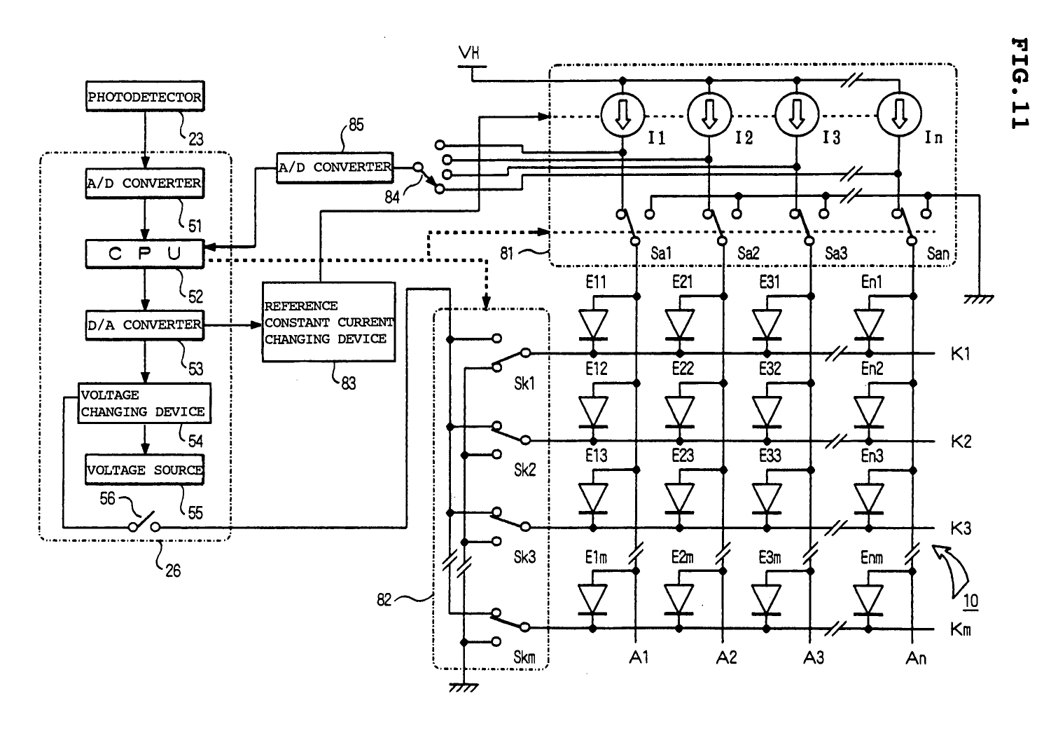

Next, FIG. 11 shows an example of a structure in which a passive drive type display panel is light emission controlled utilizing the intensity control means 26, as the passive drive type display panel is employed as the light emitting display panel 10 in the structure shown in FIG. 6. In a drive method for organic EL elements in this passive drive method, there are two methods of cathode line scan/anode line drive and anode line scan/cathode line drive, and the structure shown in FIG. 11 shows a form of the cathode line scan/anode line drive.

The display panel 10 employed here has a structure in which anode lines A1-An as drive lines and cathode lines K1-Km as scan lines are arranged in a matrix pattern and in which organic EL elements E11-Enm are respectively connected at respective intersection points of the anode lines and cathode lines arranged in this matrix pattern. An anode line drive circuit 81 is connected to anode terminals of organic EL elements E1 arranged in the display panel via the respective anode lines A1-An, and the cathode line scan circuit 82 is connected to cathodes of the respective organic EL elements arranged in the display panel via the respective cathode lines B1-Bm.

The cathode line scan circuit 82 scans, while switching switches Sk1-Skm to a ground side sequentially at constant time intervals, corresponding to a synchronization signal of a video signal so that the reference potential (O volts) is sequentially imparted to the cathode lines K1-Km. The anode line drive circuit 81 allows respective switches Sa1-San to be connected to constant current sources I1-In side which are driven by a voltage VH based on the video data, in synchronization with switch scan of the cathode lines can circuit 82, so that the drive current is supplied to organic EL elements of desired intersection points.

In the state shown in FIG. 11, only the switch Sk1 in the first line in the cathode line scan circuit 82 is connected to the ground side, so that a scan state is brought. At this time, the switches Sa1-San of the anode line drive circuit 81 are connected to the constant current sources I1-In side so that the drive current can be applied from the constant current sources I1-In to EL elements of the first cathode line via the anode lines A1-An, whereby the EL elements E1 of the first cathode line can be illuminated selectively.

This embodiment is constructed in such a manner that the output voltage from the voltage changing device 54 is supplied to other cathode lines other than the cathode line K1 which is during scanning so that a reverse bias voltage is applied to EL elements other than EL elements which are in scanning, whereby elements other than EL elements which are controlled to be lit are prevented from being erroneously illuminated. By repeating such scanning and driving at high speeds, an organic EL element of an arbitrary position is lit, and the organic EL elements are driven as if the respective EL elements were illuminated simultaneously.

Meanwhile, in driving this type of passive drive type display panel, means called a cathode reset method is adopted in which a forward voltage is precharged momentarily into the parasitic capacitance of the EL element, utilizing the voltage source which gives the reverse bias voltage to the EL elements in the non-scan state described above. This cathode reset method is disclosed for example in Japanese Patent Application Laid-Open No. 9-232074, and by adopting this method, timing of start of light emission of EL elements can be advanced, and substantial intensity decrease of the passive drive type display panel can be restrained.

When this cathode reset method is implemented, an operation is performed in which the respective scan switches Sk1-Skm are all connected to the ground for each start of scan of the respective cathode lines K1-Km and in which the respective switches Sa1-San of the anode line side also are all connected to the ground. Thus, electrical charges accumulated in parasitic capacitances of EL elements in the display panel are all reset. The scan switches corresponding to the respective scan lines other than a scan line which is scanned next are connected to the voltage source which gives the reverse bias voltage, so that the reverse bias voltage can be precharged concentratedly in the parasitic capacitances of EL elements which are driven to be lit next, via respective parasitic capacitances of other EL elements.

The inventors and the like of the present application have recognized that with the structure in which precharge is performed with respect to the parasitic capacitances of EL elements which are to be driven to be lit next, utilizing the voltage source which gives the reverse bias voltage, the light emission intensity of the EL element is substantially changed by the value of the precharge voltage, that is, the reverse bias voltage. It is considered that this is caused because the amount of precharge for the parasitic capacitance is changed corresponding to the value of the reverse bias voltage and because, corresponding to this change, light emission drive energy for the EL element is changed.

The structure shown in FIG. 11 shows one example in which the output level of the reverse bias voltage source which precharges the parasitic capacitances of EL elements is controlled by a light reception output for example of the pin diode 23 provided as the photodetector. The intensity control means designated by reference numeral 26 in FIG. 11 has approximately the same structure as that shown in FIG. 8 already described, and blocks in FIG. 11 corresponding to respective blocks in FIG. 8 are designated by the same reference numerals. Therefore, explanation for functions and operations of respective blocks designated by reference numerals 51 to 56 in FIG. 11 will be omitted.

With the structure shown in FIG. 11, based on a light detection voltage generated by the pin diode 23 provided as a photodetector, the intensity control means 26 operates to appropriately set the value of the reverse bias voltage supplied to the respective cathode lines. In the case where the amount of light received in the photodetector 23 becomes lower than the reference value for example by changes with time or by fluctuation of the environmental temperature or the like, the voltage changing device 54 in the intensity control means 26 implements control to increase the value of the reverse bias voltage and sets its state. Thus, the amount of precharge for the parasitic capacitances of the EL elements E11-Emn increases and can increase substantial light emission intensities of the EL elements. In the case where the amount of light received in the photodetector 23 increases more than the reference value for example by fluctuation of the environmental temperature or the like, an operation opposite to the above is performed, and a state in which the light emission intensities of the EL elements are decreased is set.

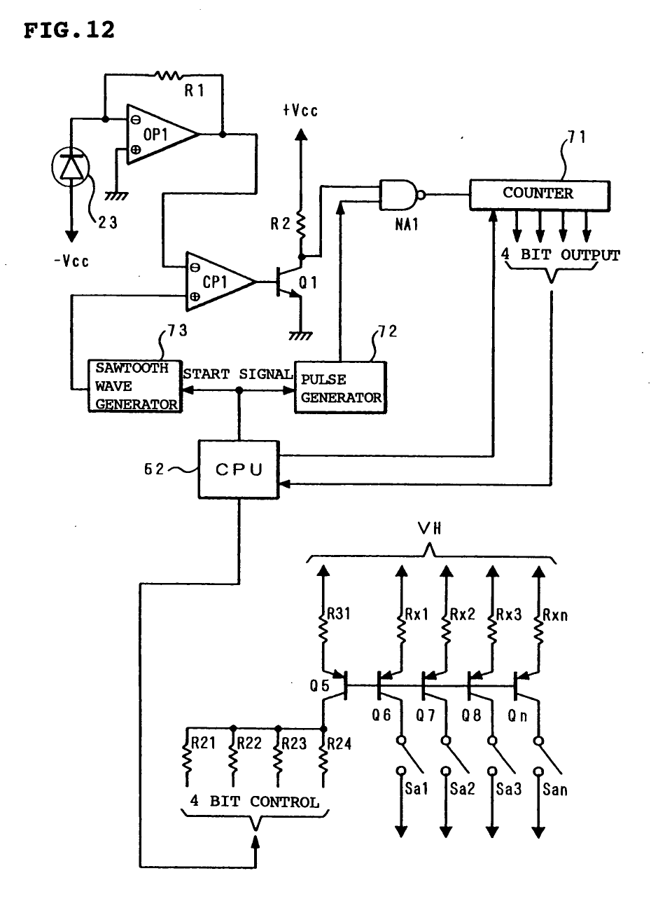

In the passive drive type display panel 10 shown in FIG. 11, a structure in which a reference constant current changing device designated by reference numeral 83 in FIG. 11 is employed as means for controlling the light emission intensities of EL elements may also be utilized suitably. FIG. 12 shows a specific structure of the case where this reference constant current changing device 83 is employed. In FIG. 12, the structure of the upper half including the CPU 52 is the same as that of FIG. 9 already described, and thus by designating the same numerals/characters, detailed description thereof will be omitted.

As shown in FIG. 12, based on the light detection voltage generated by the pin diode 23 provided as a photodetector, the CPU 52 outputs a command to selectively connect one ends of a group of resistors R21-R24 with the reference-potential point by control of 4 bits. Thus, the collector current (pull-in current) of a pnp transistor Q5 constituting the reference constant current changing device 83 is controlled.

Meanwhile, the emitter of the transistor Q5 is connected to the voltage source VH via a resistor R31. Respective bases of pnp transistors Q6-Qn functioning as the constant current sources I1-In shown in FIG. 11 are commonly connected to the base of the transistor Q5, and respective emitters of the pnp transistors Q6-Qn are respectively connected to the voltage source VH via resistors RX1-RXn. With this structure, accompanied by alteration of the collector current of the transistor Q5, the collector current in the transistors Q6-Qn, that is, drive current, which is selectively supplied to the respective EL elements E11-Enm via the switches Sa1-San can be controlled.

Therefore, in the case where the passive drive type display panel is adopted, even when the control form shown in FIG. 12 is adopted, the light emission drive current for the EL elements E11-Enm can be controlled, and it becomes possible to control the EL elements at an appropriate intensity. With this intensity control function, the intensities of the EL elements can be effectively restrained from decreasing which is for example due to changes with time. Accordingly, the respective light emitting display units 3 shown in FIGS. 3 and 4 operate to control the light emission intensities of the EL elements within a predetermined range and operate to restrain variations in the light emission intensities from occurring for each light emitting display unit. Therefore, in the form shown in FIGS. 3 and 4, in the case where the respective light emitting display units 3 are exchanged, occurrence of variations that the exchanged light emitting display unit 3 emits light more brightly compared to other units or the like can be restrained.

Meanwhile, the embodiment shown in FIG. 11 is constructed in such a manner that the electrical potentials at the respective constant current sources I1-In are drawn and are alternatively selected by a select switch 84. The electrical potentials at the constant current sources 11-In correspond to voltages between terminals of EL elements in the scan state, and are utilized to verify the deterioration state of EL elements. A voltage between terminals which is alternatively selected by the select switch 84 is converted into digital data by an A/D converter 85. This digital data is supplied to the CPU 52 and is written in an unillustrated data memory (memory means) arranged in the CPU 52 so that the deterioration state of EL elements is determined.

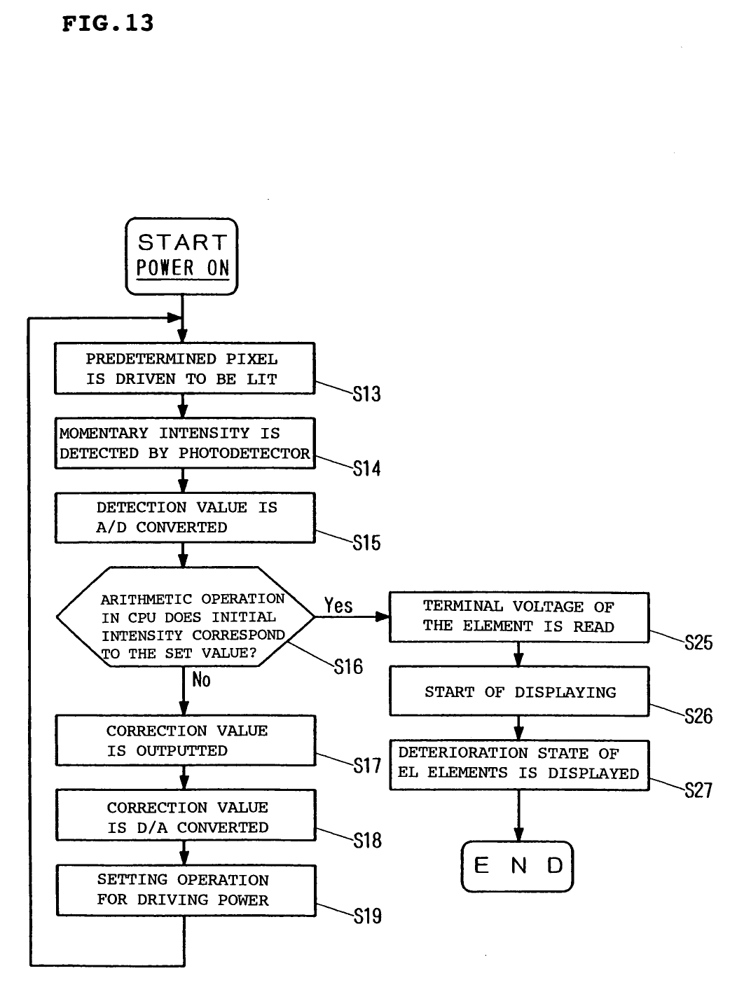

FIG. 13 is to explain a control routine for reporting setting of the driving power of the passive drive type light emitting display unit 3 shown in FIGS. 11 and 12 and the deterioration state of EL elements in the light emitting display unit 3. The routine shown in this FIG. 13 is respectively implemented for each light emitting display unit 3 in a state in which the light emitting display units 3 are disposed in vertical and horizontal directions to construct a large size screen as shown in FIGS. 3 and 4 and in which the operational power supply thereof is turned on. The routine shown in this FIG. 10 can be executed also in a single unit of the light emitting display unit 3.

Steps S13-S19 in FIG. 13 show set routine for the driving power in the light emitting display unit 3 and are the same as steps S13-Sl9 shown in FIG. 10 already described. Therefore, explanation for these set routine for the driving power will be omitted. In step S25 in FIG. 13, reading of the voltage between terminals of the EL element is implemented. Here, operations are performed wherein the voltage between terminals which is alternatively selected by the select switch 84 is converted into digital data by the A/D converter 85 and is written in the data memory disposed in the CPU 52 as described above.

Process proceeds to step S26, and displaying an image, utilizing all pixels in the display panel 10, is started. In this embodiment, the deterioration state of EL elements is displayed as shown in step S27 at the same time as the beginning of displaying an image. Here, digital data based on the terminal voltage fetched in step S25 is utilized.

In this case, as one example to display the deterioration state of EL elements, similarly to the example of the active drive type already described, means for displaying an image in the display panel 10 constituting the light emitting display units 3 by a specific light emitting color or the like can be adopted. It can be considered also that advance degree of deterioration is displayed by a numerical value on the display units 3.

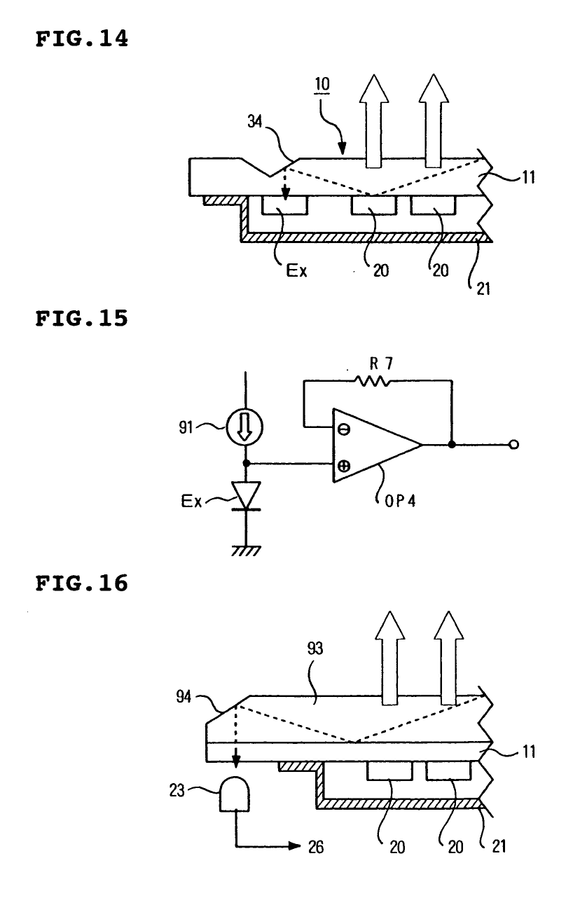

Although the respective forms described above are constructed in such a manner that the pin diode 23 as a photodetector is equipped separately from the display panel, an EL element laminated and formed on the substrate of the display panel can also be utilized as a photodetector described above. FIG. 14 shows one example thereof by a cross-sectional view, wherein an EL element Ex which is for receiving light and which is not utilized as a display function is utilized. That is, in the embodiment shown in this FIG. 14, EL elements 20 for emitting light are formed on one surface of a substrate 11 by film formation, and at the same time the light-receiving EL element Ex also can be formed.

Similarly to the example shown in FIG. 7B, a groove portion 34 whose cross-sectional shape is constructed into the form of a V along a portion in the vicinity of one end portion of the substrate 11 is provided, and one surface of the groove portion is utilized as a reflective surface, so that reflected light shown by the broken line can be introduced into the light-receiving EL elements Ex. Here, the organic EL element has a characteristic that in a case where a predetermined constant current is forwardly applied to the EL element, the forward voltage thereof changes in response to extraneous light that the EL element receives. In this case, the EL element has a characteristic that the forward voltage of the element becomes lower as the amount of light that the EL element receives becomes greater.

FIG. 15 shows one example in which a photoelectric transfer circuit is constructed utilizing the dependency of the forward voltage corresponding to the illumination intensity that the EL element Ex receives. That is, a constant current is supplied to the anode of the EL element Ex via a constant current source 91. The anode is connected to the non-inverting input terminal of an op amp OP4, and the cathode is connected to the ground. The op amp OP4 constitutes a well-known negative feedback buffer in which a feedback resistor R7 is connected to the inverting input terminal from the output terminal, and thus a DC voltage corresponding to the forward voltage of the EL element Ex is given to the output terminal of the op amp OP4.

Therefore, by inputting a signal to the comparator 73 shown in FIGS. 9 and 12, utilizing the output voltage of the op amp oP4 shown in FIG. 15, the light emission driving power given to the EL elements can be appropriately set as described already.

In the embodiments described above, the transparent substrate 11 in which for example organic EL elements as EL elements are laminated and formed is utilized, and light which is from the EL elements and which is reflected within the substrate, treating the substrate surfaces as the boundary surfaces, is received to obtain the electrical signal. However, for example as shown in FIG. 16, it is also possible to utilize a light guide substrate which is further laminated on the transparent substrate 11 and to receive light which is from EL elements and which is reflected, treating the substrate surfaces thereof as the boundary surfaces, to obtain the electrical signal.

That is, in FIG. 16, the same functional parts as those for example of FIG. 6 already described are designated by the same reference numerals, and therefore detailed explanation therefor will be omitted. In this form shown in FIG. 16, a light guide substrate 93 is further attached on the front surface of the transparent substrate 11 on which for example the organic EL elements 20 as EL elements are laminated and formed in a state in which the light guide substrate 93 is laminated. A reflective surface 94 is formed at a predetermined angle with respect to the substrate surface of the light guide substrate 93, and light which is totally reflected, treating the substrate surfaces of the light guide substrate 93 as the boundary surfaces, and which is shown by the broken line is reflected in the rear surface side of the substrate 11 via the light guide substrate 93 and the transparent substrate 11 by means of this reflective surface 94.

Therefore, with this structure, by arranging for example the pin diode 23 as a photodetector in the rear surface side of the transparent substrate 11 constituting the display panel 10, the amount of light reflected by the reflective surface 94 formed in the light guide substrate 93 can be detected. In this manner, with the structure utilizing the light guide substrate 93, the present invention can also be applied easily even to a display device in which for example a film is employed as the substrate 11.

1. A light emitting display device characterized by forming one display screen by combining a plurality of light emitting display units comprising intensity control means for measuring a light emission intensity by a light emitting element which is formed above/on a transparent substrate and which includes an anode electrode, a cathode electrode, at least one organic light emission functional layer between the electrodes to control the light emission intensity of the light emitting element above/on the substrate within a predetermined range and deterioration state reporting means for detecting a deterioration state of the light emitting element above/on the substrate to report the state.

2. The light emitting display device according to claim 1, characterized in that the intensity control means is composed of photoelectric transfer means for receiving light which is from the light emitting element and which is reflected within the substrate, treating substrate surfaces of the transparent substrate or substrate surfaces of a light guide substrate arranged above/on the transparent substrate in a stacked state as boundary surfaces, to generate an electrical signal and driving power setting means for setting a light emission driving power supplied to the respective light emitting elements based on the electrical signal obtained by the photoelectric transfer means.

3. The light emitting display device according to claim 1, characterized in that the deterioration state reporting means is constructed in such a manner that the deterioration state is detected based on a voltage between terminals and/or a terminal current of the time when the light emitting element on the transparent substrate operates to emit light.

4. The light emitting display device according to claim 3 characterized by being constructed in such a manner that the deterioration state reporting means is provided with comparison means for comparing the voltage between terminals and/or the terminal current with a reference value to drive the reporting means based on a difference between comparison results obtained by the comparison means.

5. The light emitting display device according to any one of claims 1 to 4, characterized in that light emitting elements which emit a plurality of different light emission colors are formed above/on the transparent substrate which constitutes the light emitting display unit.

6. The light emitting display device according to any one of claims 1 to 4, characterized in that light emitting elements which emit a single light emission color are formed above/on the transparent substrate which constitutes the light emitting display unit.

7. The light emitting display device according to any one of claims 1 to 4, characterized in that sealing means for sealing the light emitting elements respectively formed above/on the transparent substrate between the transparent substrate and the sealing means is disposed in the light emitting display unit.

8. The light emitting display device according to claim 5, characterized in that sealing means for sealing the light emitting elements respectively formed above/on the transparent substrate between the transparent substrate and the sealing means is disposed in the light emitting display unit.

9. The light emitting display device according to claim 6, characterized in that sealing means for sealing the light emitting elements respectively formed above/on the transparent substrate between the transparent substrate and the sealing means is disposed in the light emitting display unit.

10. The light emitting display device according to any one of claims 2 to 4, characterized in that the light emitting element including an organic light emission functional layer formed above/on the transparent substrate which constitutes the light emitting display unit is utilized as a photodetector in the photoelectric transfer means.

11. The light emitting display device according to claim 5, characterized in that the light emitting element including an organic light emission functional layer formed above/on the transparent substrate which constitutes the light emitting display unit is utilized as a photodetector in the photoelectric transfer means.

12. The light emitting display device according to claim 6, characterized in that the light emitting element including an organic light emission functional layer formed above/on the transparent substrate which constitutes the light emitting display unit is utilized as a photodetector in the photoelectric transfer means.

13. The light emitting display device according to claim 7, characterized in that the light emitting element including an organic light emission functional layer formed above/on the transparent substrate which constitutes the light emitting display unit is utilized as a photodetector in the photoelectric transfer means.

14. The light emitting display device according to claim 8, characterized in that the light emitting element including an organic light emission functional layer formed above/on the transparent substrate which constitutes the light emitting display unit is utilized as a photodetector in the photoelectric transfer means.

15. The light emitting display device according to claim 9, characterized in that the light emitting element including an organic light emission functional layer formed above/on the transparent substrate which constitutes the light emitting display unit is utilized as a photodetector in the photoelectric transfer means.
